(19) United States
(12) Patent Application Publication
(10) Pub. No.: US 2006/0285193 A1
(43) Pub. Date: Dec. 21, 2006

(54) Optical modulation element array

(75) Inventors: Koichi Kimura, Kanagawa (JP); Shinya Ogikubo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/446,210

(22) Filed: Jun. 5, 2006

(30) Foreign Application Priority Data
Jun. 3, 2005 (JP) P. 2005-164571

(51) Int. Cl. G02B 26/00

(52) U.S. Cl. 359/291

(57) ABSTRACT

An optical modulation element array includes: a substrate and optical modulation elements two-dimensionally arranged in a first direction and a second direction, the first direction being perpendicular to the second direction, and at least a portion of the end of the hinge is disposed in a gap between optical modulation elements next to each other in the first direction, the optical modulation elements next to each other in the first direction is located next to the optical modulation elements having the end of the hinge, in the second direction.

### BACKGROUND OF THE INVENTION

1. Field of the Invention

The invention relates to an optical modulation element array mounted on various optical apparatuses, e.g., an on-demand digital exposure apparatus used in a photolithography process, an image forming apparatus, such as a digital exposure printer, a projection display apparatus, such as a projector, or a micro display apparatus, such as a head-mounted display. More particularly, the invention relates to an optical modulation element array in which an optical modulation element of rotational displacement type is arranged one-dimensionally or two-dimensionally by the MEMS (Micro Electro Mechanical Systems) technology.

2. Background Art

Liquid crystal elements, elements using electro-optic crystal or magneto-optic crystal, or optical modulation elements according to the MEMS technology are known as optical modulation elements mounted on an optical apparatus, e.g., an on-demand digital exposure apparatus used in a photolithography process, an image forming apparatus, such as a digital exposure printer, a projection display apparatus, such as a projector, or a micro display apparatus, such as a head-mounted display.

Among these elements, especially the optical modulation element according to the MEMS technology is superior in high speed capability, in array-type high integrity capability, and in the degree of freedom of wavelength selection from the ultraviolet region (UV) to the infrared region (IR), so that various optical modulation elements, such as a DMD (digital micro mirror device), have been developed.

As shown in FIG. 7, an optical modulation element of rotational displacement type (hereinafter also simply referred to as an “optical modulation element”) 1 using a twistable hinge can be mentioned as one of these optical modulation elements. In the optical modulation element 1, a quadrangular reflecting mirror (micro mirror) 5 including movable electrode films, not shown, is disposed above a substrate 3 with an interval therebetween. A hinge 7 parallel to a pair of sides of the micro mirror 5 is extended in the middle of the micro mirror 5 parallel to the other pair of sides thereof. The hinge 7 is supported by the substrate 3 with hinge supporting parts 9 between the hinge 7 and the substrate 3. A pair of driving electrode films 11a and 11b is disposed on the substrate 3 on both sides of the hinge 7 so as to face the micro mirror 5.

In the optical modulation element 1, voltage applied to the movable electrode films of the micro mirror 5 and voltage applied to the driving electrode films 11a and 11b are controlled, so that an electrostatic force is generated between the electrodes, and the micro mirror 5 swings as illustrated in FIG. 8A and FIG. 8B. As a result, light reflected by the micro mirror 5 can be deflected.

However, when the micro mirror 5 is structured to include the movable electrode films as mentioned above, the hinge 7 is disposed outside the micro mirror 5. Therefore, the ratio of an effective area (i.e., area of the micro mirror 5) to a pixel area is lowered. Therefore, if a number of optical modulation elements 1 are arrayed in two-dimensional form as illustrated in FIG. 9, the hinges 7 of adjoining micro mirrors 5 are arranged in the same direction, and will interfere with each other. As a result, disadvantageously, a large ineffective area 13 will be generated to lower the aperture ratio.

Additionally, in order to drive the optical modulation element 1 at a low voltage, the twist elastic coefficient of the hinge 7 must be lowered. To lower the twist elastic coefficient of the hinge 7, there is a need to select at least one of a decrease in Young's modulus of hinge film material, a decrease in hinge thickness, a decrease in hinge width, and an increase in hinge length. However, there are limitations on a decrease in Young's modulus of hinge film material, a decrease in hinge thickness, and a decrease in hinge width. Therefore, in general, an increase in hinge length is employed as a simple adjustment, in order to lower the twist elastic coefficient. However, if the optical modulation elements 1 are arrayed in two-dimensional form, the hinges 7 are arranged in the same direction as illustrated in FIG. 9, and interference will occur between the hinges 7. Therefore, the ineffective area 13 is further enlarged, and the aperture ratio is further lowered.

To overcome these disadvantages, an optical modulation element in which a micro mirror is disposed above a hinge has been proposed as disclosed in JP-A-8-334709 (the term “JP-A” as used herein means an unexamined published Japanese patent application) and JP-A-2000-028937.

FIG. 10 is an exploded perspective view of an optical modulation element 15 described in JP-A-8-334709.

A pair of driving electrode films 19a and 19b fixed to a substrate 17 for each rectangular pixel and a pair of common electrode films 21a and 21b fixed to the substrate 17 for each rectangular pixel are formed on the substrate 17. A hinge shaft 23 is bridged between the common electrode films 21a and 21b. Movable electrode films 25a and 25b constructed integrally with the hinge shaft 23 are respectively disposed on both sides of the hinge shaft 23. A supporting rod 27 is erected at the middle of the hinge shaft 23. A reflective film 29 that functions as a reflecting mirror (micro mirror) is attached to the supporting rod 27. The common electrode films 21a and 21b, the hinge shaft 23, the movable electrode films 25a and 25b, the supporting rod 27, and the reflective film 29 are electrically connected together, and are the same in electric potential.

In the optical modulation element 15 as mentioned above, an electrostatic force is generated between the movable electrode films 25a and 25b and the driving electrode films 19a and 19b by controlling the voltage applied to the common electrode films 21a and 21b, i.e., the voltage applied to the movable electrode films 25a and 25b that are the same as the common electrode films 21a and 21b in electric potential and the voltage applied to the driving electrode films 19a and 19b. The hinge shaft 23 is twisted by this electrostatic force, and the reflective film 29 is rotated as illustrated by arrow B. When light is projected onto the reflective film 29, the direction of the reflected light thereof can be changed by rotating the reflective film 29, so that light in the reflected direction can be controllably turned on or off.

FIG. 11 is an exploded perspective view of a part, which corresponds to a single rectangular pixel, of an optical modulation element 31 described in JP-A-2000-028937. Driving electrode films 35a and 35b and common electrode films 37a and 37b are mutually disposed in diagonal position on a substrate 33. Supporting rods 39a and 39b are erected on the common electrode films 37a and 37b, respectively. Triangular hinge shaft supporting pieces 41a and 41b are attached to the supporting rods 39a and 39b, respectively. A hinge shaft 43 is bridged between the hinge shaft supporting pieces 41a and 41b. On both sides of the hinge shaft 43, a movable electrode film 45 is formed integrally with the hinge shaft 43. A projection (not shown) that protrudes downwardly is disposed at the middle of a reflective film 47. The reflective film 47 can be rotated together with the movable electrode film 45 by attaching this projection to the center of the movable electrode film 45. Each of the hinge shaft supporting pieces 41a and 41b is provided with projections 41c and 41d extending along each side of the triangle. In FIG. 11, reference character 47a designates a position that comes into contact with each of the projections 41c and 41d when the reflective film 47 is rotated and tilted. The common electrode films 37a and 37b, the hinge shaft supporting pieces 41a and 41b, the projections 41c and 41d, the hinge shaft 43, the movable electrode film 45, the supporting rod 27, and the reflective film 47 are electrically connected together, and are the same in electric potential.

Likewise, in this optical modulation element 31, the rotation, i.e., tilt of the reflective film 47 is controlled by controlling the voltage applied to the driving electrode films 35a and 35b and the voltage applied to the common electrode films 37a and 37b, i.e., the voltage applied to the movable electrode film 45. Therefore, reflected light can be controllably turned on or off in the reflected direction.

As another example, a DMD structure in which pixels are disposed in a zigzag alignment so as to heighten the aperture ratio is disclosed in JP-A-8-036141. As illustrated in FIG. 12, in an optical modulation element array 51 having a DMD structure, alternate rows in the array are arranged in a zigzag alignment in order to increase the effective horizontal resolution, and a micro mirror 53 is supported by hinges 55 disposed on both ends in the diagonal direction, and the hinge 55 is disposed in parallel with an adjoining hinge 55 belonging to another row with a misalignment, thus forming a basic array of digital micro mirror elements.

However, in the element structure illustrated in FIGS. 10 and 11 in which the micro mirror and the movable electrode film are disposed to have a two-layer construction, the supporting hinge for micro mirror is covered with the corresponding micro mirror. Therefore, if the hinge is lengthened for a low voltage, the micro mirror concealing the hinge must be proportionately enlarged. As a result, mass required to be driven and displaced is increased, and the moment of inertia in the rotation system is increased, and, accordingly, displacement responsibility is lowered.

Additionally, in the element structure illustrated in FIG. 12 in which the micro mirrors are arranged in a zigzag alignment, the hinges are never aligned. However, since the micro mirror and the hinge are disposed on the same plane, the area of the micro mirror becomes small after all if the hinge is lengthened. Therefore, the aperture ratio is lowered.

### SUMMARY OF THE INVENTION

The invention has been made in consideration of these circumstances. It is an object of the invention to provide an optical modulation element array capable of lengthening a hinge without enlarging a micro mirror so that the aperture ratio in an optical modulation element can be secured, and an operation performed at a low voltage can be accomplished while preventing a decrease in displacement responsibility.

The object of the invention is achieved by the following structures.

(1) An optical modulation element array comprising: a substrate and a plurality of optical modulation elements two-dimensionally arranged in a first direction and a second direction, the first direction being perpendicular to the second direction, wherein (1) the plurality of the optical modulation elements in the first direction are linearly arranged side by side, and the plurality of the optical modulation elements in the second direction are arranged so that optical modulation elements next to each other are shifted in the first direction, (2) each of the plurality of the optical modulation elements comprises: an optical function film provided above the substrate; a hinge that supports the optical function film, the optical function film being capable of being tilted, wherein the hinge extends in parallel with the second direction; and a first support that connects an end of the hinge with the substrate; and (3) at least a portion of the end of the hinge is disposed in a gap between the optical modulation elements next to each other in the first direction, the optical modulation elements next to each other in the first direction are located next to the optical modulation element having the end of the hinge, in the second direction.

(2) The optical modulation element array described in the item (1), wherein the entire portion of the end of the hinge is disposed in the gap.

According to the optical modulation element array described in the item (1) or (2), the optical modulation elements are arranged so that optical modulation elements next to each other are shifted in the first direction (hereinafter also simply referred to as a zigzag alignment), and the end of the hinge provided in parallel with the second direction is disposed in a gap between the optical modulation elements adjoining along the first direction. Therefore, each of the hinges adjoining in the second direction never interferes with each other. In other words, since the hinge is disposed in a gap between the optical modulation elements adjoining along the second direction, each of the ends of the hinge never come into contact with each other. As a result, the hinge can be lengthened without enlarging the optical function film.

According to the optical modulation element array described in the item (1) or (2), wherein a height of the optical function film on the basis of an upper surface of the substrate is greater than that of the hinge and that of the first support.

According to the optical modulation element array described in the item (3), the optical function film can be floated and disposed above the hinge and the first support. In other words, a space in which only the optical function film can be disposed is secured on the upper layer differing from the lower layer on which the hinge and the first support are disposed. Therefore, a space to dispose the hinge and the first support and the area of the optical function film can be made larger, and optical efficiency in optical modulation can be made higher than in the conventional structure in which the hinge, the first support, and the optical function film are disposed on the same plane.

(4) The optical modulation element array described in the items (1) to (3), wherein the optical function film has a second support, the second support protruding toward the upper surface of the substrate, and the second support connects the optical function film to the hinge.

According to the optical modulation element array described in the item (4), the optical function film is connected to the hinge through the second support, and the elastic coefficient exhibited when the optical function film operates while rotating is restricted to a small value. Therefore, the optical modulation element array can be driven at a low voltage, and can respond at a high speed. Additionally, since the length of the hinge in the axial direction can be further increased, the low-voltage drivability and the rapid responsibility can be improved.

(5) The optical modulation element array described in the items (1) to (4), which comprises: a movable film having an electrode layer, supported by the hinge in parallel with the optical function film, and connected to the hinge; and a fixed electrode provided on the substrate and facing at least one of an area of the electrode layer, the area divided by the hinge.

According to the optical modulation element array described in the item (5), an electrostatic force is generated between the electrode layers and the fixed electrodes. This electrostatic force is used as the displacement drive source of the optical function film. In other words, the movable film that is nearer to the substrate than to the optical function film is allowed to generate an electrostatic force, and hence a greater electrostatic force can be obtained. Therefore, drivability at a lower voltage can be achieved, and the optical function film can respond at a greater speed.

(6) The optical modulation element described in the items (1) to (5), wherein the optical function film is a micro mirror.

According to the optical modulation element array described in the item (6), since the optical function film is a micro mirror, the hinge is lengthened, and the twist elastic coefficient thereof is reduced.

According to an as aspect of the invention, the optical modulation elements is arranged in a zigzag alignment, and the end of the hinge provided in parallel with the second direction is disposed in a gap between the optical modulation-element adjoining along the first direction. Therefore, the hinge can be lengthened without enlarging the optical function film. In other words, the hinge can be lengthened while maintaining the aperture ratio of the optical modulation elements, and the twist elastic coefficient thereof can be reduced. As a result, low-voltage drivability can be achieved while preventing a decrease in displacement responsibility.

### BRIEF DESCRIPTION OF THE DRAWINGS

The invention disclosed herein will be understood better with reference to the following drawings of which:

FIG. 1 is a plan view of an optical modulation element array according to a first embodiment in which optical modulation elements are arranged in a zigzag alignment;

FIG. 2 is a plan view of an optical modulation element array according to a second embodiment in which micro mirrors are floated and disposed by micro mirror supporting portions;

FIG. 3A and FIG. 3B are schematic explanatory drawings, FIG. 3A illustrating a cross section along line B-B in FIG. 2, FIG. 3B illustrating a cross section along line C-C in FIG. 2;

FIG. 4A to FIG. 4F are explanatory drawings illustrating the manufacturing procedure of the optical modulation elements in FIG. 2;

FIG. 5 is a plan view of an optical modulation element array according to a third embodiment in which a movable film is provided;

FIG. 6A to FIG. 6C are schematic explanatory drawings, FIG. 6A illustrating a cross section along line D-D in FIG. 5, FIG. 6B illustrating a cross section along line E-E in FIG. 5, FIG. 6C illustrating a cross section along line F-F in FIG. 5;

FIG. 7 is a perspective view of an optical modulation element of related art;

FIG. 8A and FIG. 8B are drawings explaining the operation of the optical modulation element in FIG. 7;

FIG. 9 is a plan view of an optical modulation element array using the optical modulation elements in FIG. 7;

FIG. 10 is a perspective view of a conventional optical modulation element array in which micro mirrors are disposed above hinges;

FIG. 11 is an exploded perspective view of another conventional optical modulation element array in which micro mirrors are disposed above hinges; and

FIG. 12 is a plan view of a conventional optical modulation element array in which pixels are arranged in a zigzag alignment.

### DETAILED DESCRIPTION OF THE INVENTION

Exemplary embodiments of an optical modulation element array according to the invention are described below with reference to the drawings. However, it is to be understood that the invention is not intended to be limited to the specific embodiments.

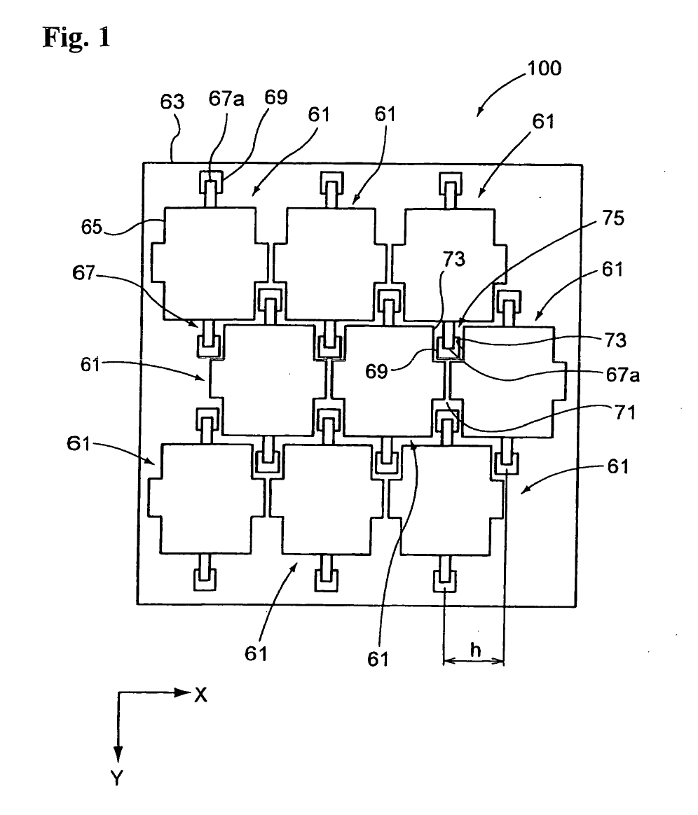

FIG. 1 is a plan view of an optical modulation element array according to a first embodiment in which optical modulation elements using micro mirrors serving as optical function films are arranged in a zigzag alignment.

The optical modulation element array 100 according to this embodiment includes an array of optical modulation element 61. The optical modulation element 61 includes a micro mirror 65 serving as an optical function film provided above a substrate 63, a hinge 67 supporting the micro mirror 65 so that the micro mirror 65 can be tilted, and a first support 69 by which an end 67a of the hinge 67 is connected to the substrate 63.

In the optical modulation element 61, an electrode layer, not shown, is provided on the micro mirror 65, and a pair of fixed electrodes, not shown, disposed on either side of the hinge 67 are provided on the substrate 63. In the optical modulation element 61, the micro mirror 65 is driven by the pair of fixed electrodes. The micro mirror 65 undergoes an electrostatic force generated thereby, and is stably moved to a left tilt position and a right tilt position with the hinge 67 as the twist center therebetween. The optical modulation element array 100 operates while reflecting light from the micro mirror 65 of each optical modulation element 61. In other words, each optical modulation element 61 represents one pixel of an image.

In the optical modulation element array 100, according to a micro electromechanical technique, the optical modulation elements 61 are two-dimensionally arranged in first and second directions (i.e., X and Y directions of FIG. 1) that intersect perpendicularly. The first and second directions may be either the row-wise direction or the column-wise direction of an image formed by writing data about all pixels.

In the first direction X, the optical modulation elements 61 are rectilinearly arranged side by side. On the other hand, in the second direction Y, the optical modulation elements 61 are arranged in a zigzag alignment so as to have a phase lag in the first direction X of substantially half the single element (i.e., size “h” illustrated in FIG. 1) with respect to the optical modulation element 61 adjoining in the second direction Y. In the optical modulation element 61, the hinge 67 is formed in parallel with the second direction Y. The end 67a of the hinge 67 in each optical modulation element 61 is disposed in a gap 71 of the optical modulation element 61 adjoining in the first direction X.

The terms “parallel” and “perpendicular” recited in this description are not used in their strict senses, and include the senses of “roughly parallel” and “roughly perpendicular.”

The micro mirror 65 has cutouts 73 formed at parts that correspond to both ends in the extending direction (i.e., upward and downward directions of FIG. 1) of the gap 71. As a result, concave portions 75 are formed at both ends of the gap 71, respectively. The end 67a of the hinge 67 and the first support 69 are disposed at the concave portion 75.

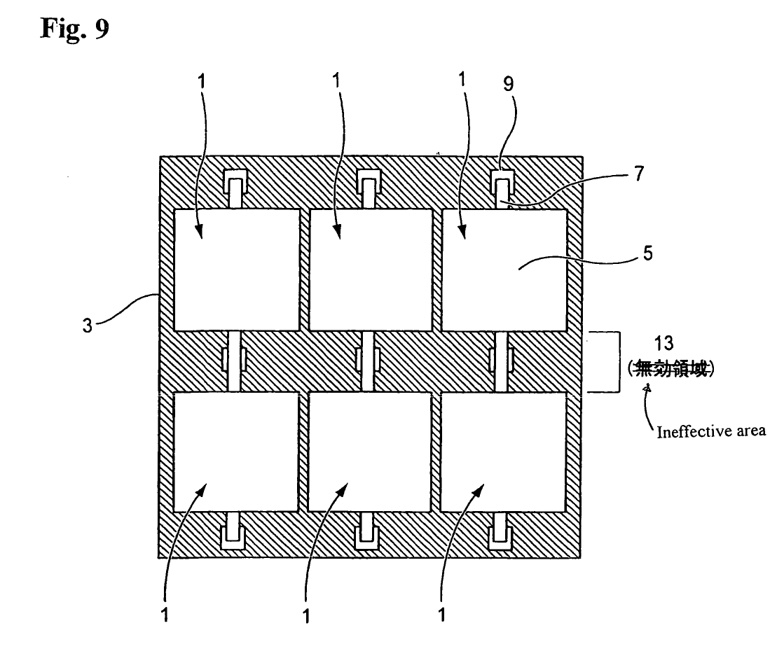

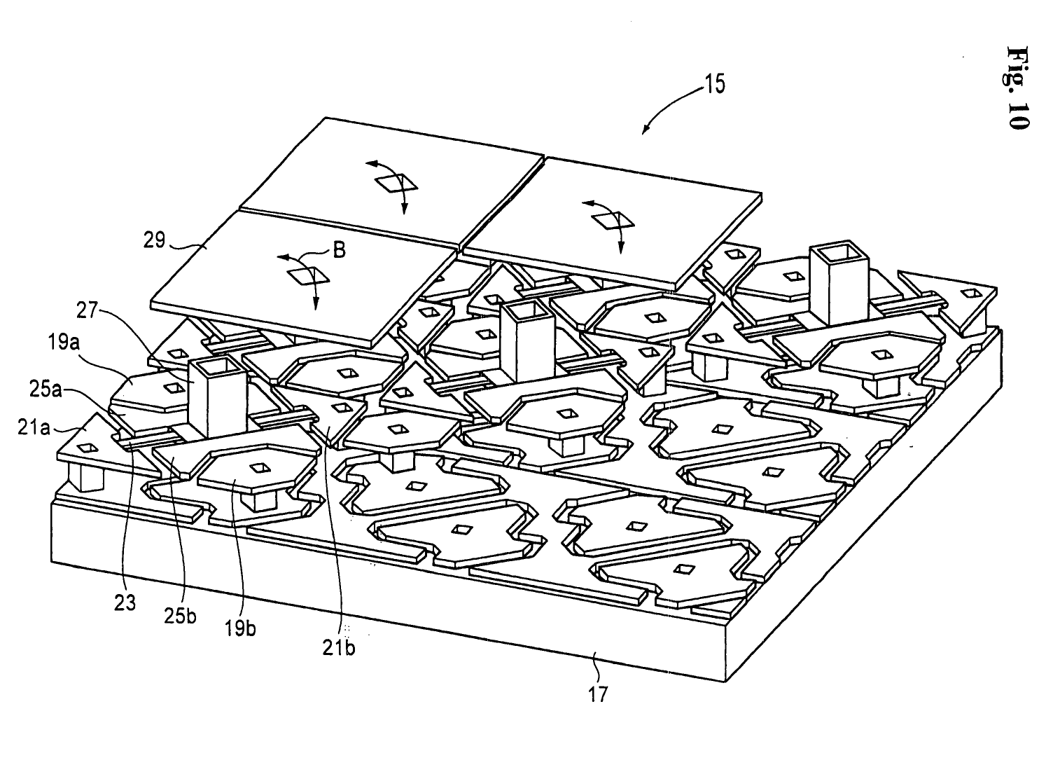

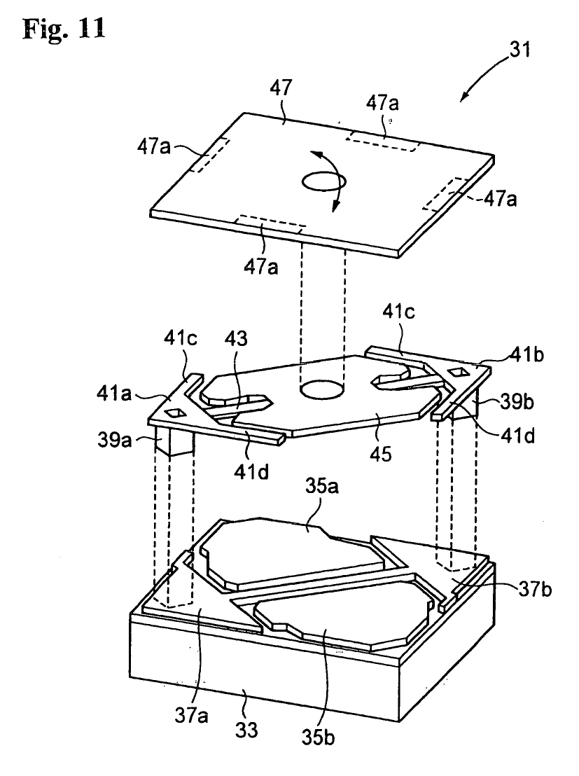

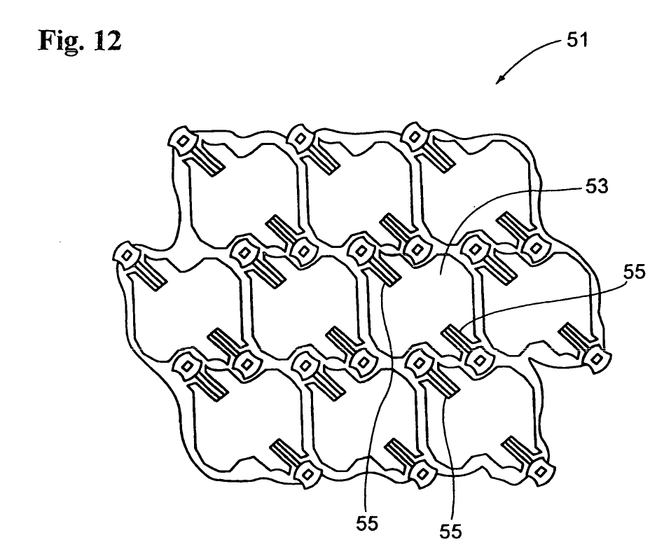

Therefore, according to the optical modulation element array 100, the optical modulation elements 61 are arranged in a zigzag alignment, and the end 67a of the hinge 67 formed in substantially parallel with the second direction Y is disposed at the gap 71 of the optical modulation element 61 adjoining in the first direction X. Therefore, a case never occurs in which, as illustrated in FIG. 9, the hinges 7 of the adjoining micro mirrors 5 are arranged in the same direction so as to cause interference, and a large ineffective area 13 is generated so as to lower the aperture ratio. Additionally, the hinge 67 can be lengthened without enlarging the micro mirror 65. In other words, the hinge 67 can be lengthened, and the twist elastic coefficient can be reduced while maintaining the aperture ratio of the optical modulation element 61. As a result, the operation at a low voltage can be accomplished while preventing a decrease in displacement responsibility.

Next, a second embodiment of the optical modulation element array according to the invention will be described.

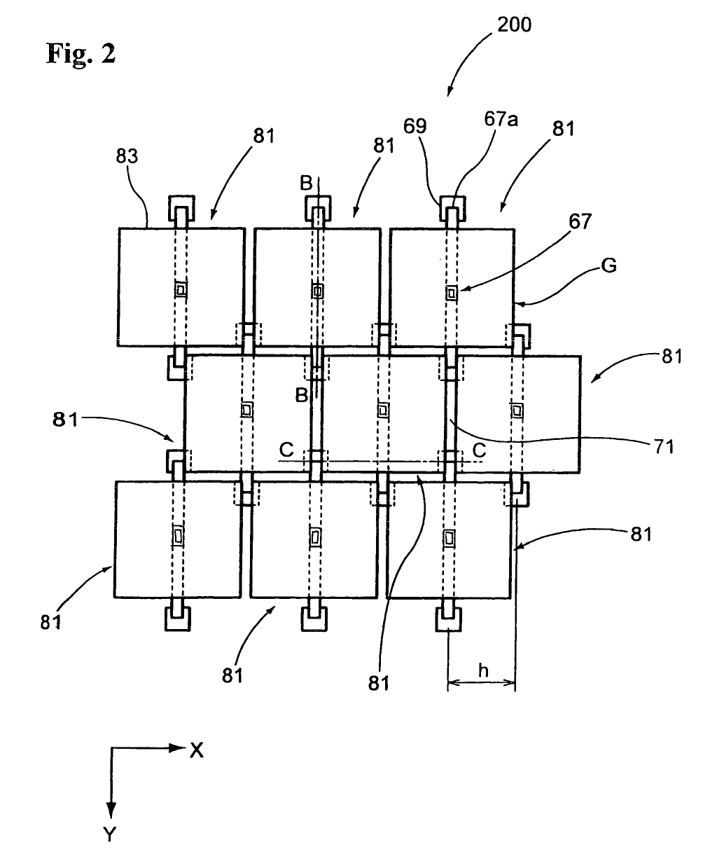

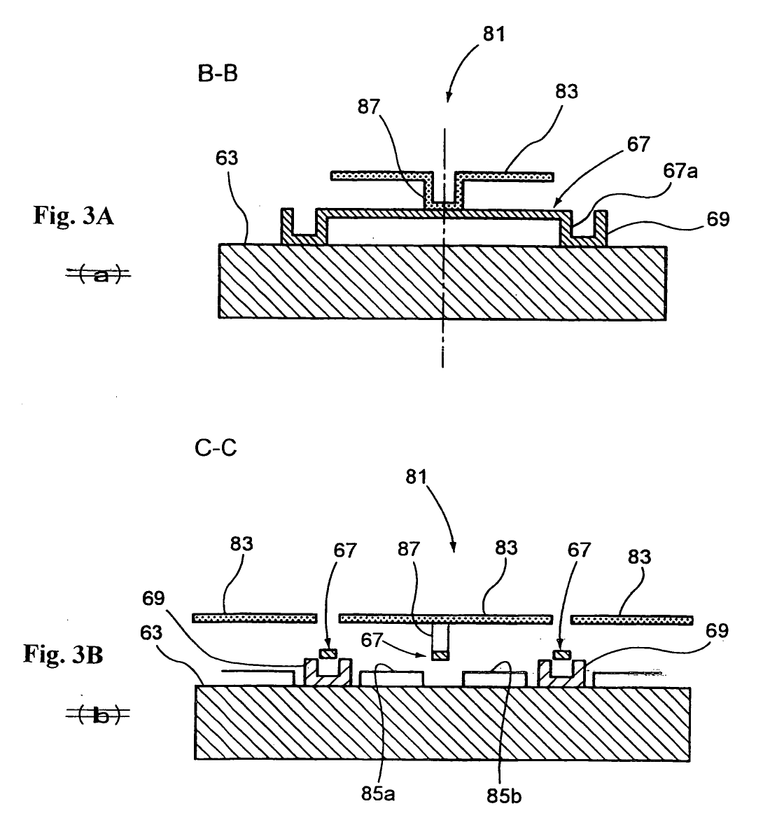

FIG. 2 is a plan view of the optical modulation element array according to the second embodiment in which a micro mirror is floated and disposed by a supporting portion for micro mirror (supporting portion for optical function film). FIGS. 3A and 3B are schematic drawings, FIG. 3A explaining a sectional view along line B-B in FIG. 2, FIG. 3B explaining a sectional view along line C-C in FIG. 2. In this embodiment, the same reference character is given to the same member as in FIG. 1, and overlapping description thereof is omitted.

The optical modulation element array 200 includes an array of optical modulation elements 81. The optical modulation element 81 includes a micro mirror 83 provided above a substrate 63 (see FIGS. 3A and 3B), a hinge 67 supporting the micro mirror 83 so that the micro mirror 83 can be tilted, and a first support 69 by which an end 67a of the hinge 67 is connected to the substrate 63.

The optical modulation element 81 includes the micro mirror 83 used also as a movable electrode, and a pair of fixed electrodes 85a and 85b disposed in either side of the hinge 67 on the substrate 63. In the optical modulation element 81, the micro mirror 83 is driven by the pair of fixed electrodes 85a and 85b. The micro mirror 83 undergoes an electrostatic force generated thereby, and is stably moved to a left tilt position and a right tilt position with the hinge 67 as the twist center. The optical modulation element array 200 operates while reflecting a light from the micro mirror 83 of each optical modulation element 81. In other words, each optical modulation element 81 represents one pixel G of an image (see FIG. 2).

In the optical modulation element array 200, according to a micro electromechanical technique, the optical modulation elements 81 are two-dimensionally arranged in first and second directions (i.e., X and Y directions of FIG. 2) that intersect perpendicularly each other. The first and second directions may be either the row-wise direction or the column-wise direction of an image formed by writing data about all pixels.

In the first direction X, the optical modulation elements 81 are rectilinearly arranged side by side. On the other hand, in the second direction Y, the optical modulation elements 81 are arranged in a zigzag alignment so as to have a phase lag in the first direction X of substantially half the single element (i.e., size “h” illustrated in FIG. 2) with respect to the optical modulation element 81 adjoining in the second direction Y. In the optical modulation element 81, the hinge 67 is formed in parallel with the second direction Y. The end 67a of the hinge 67 in each optical modulation element 81 is disposed in a gap 71 of the optical modulation element 81 adjoining in the first direction X.

In the optical modulation element 81, the micro mirror 83 has a supporting portion for micro mirror 87 that protrudes toward the upper surface of the substrate 63. The micro mirror 83 is connected to the hinge 67 through the supporting portion for micro mirror 87. The micro mirror 83 is floated and disposed by the supporting portion for micro mirror 87, and becomes higher than the hinge 67 and the first support 69. As a result, the end 67a of the hinge 67 and the first support 69 can be disposed in the gap 71 without forming the cutout 73 (see FIG. 1) in the micro mirror 83. In other words, the micro mirror 83 is formed with a high aperture ratio that does not need to form the cutout 73.

In the optical modulation element array 200 as mentioned above, the micro mirror 83 having an electrode layer is tilted by an electrostatic force generated when voltage is applied onto the electrode layer and the fixed electrodes 85a and 85b. That is, the fixed electrodes 85a and 85b are symmetrically disposed in an area divided by the hinge 67, and the micro mirror 83 is rotated and displaced in accordance with the applied voltage between the electrode layer and the fixed electrodes 85a and 85b.

Next, a method for manufacturing the optical modulation element array 200 will be described.

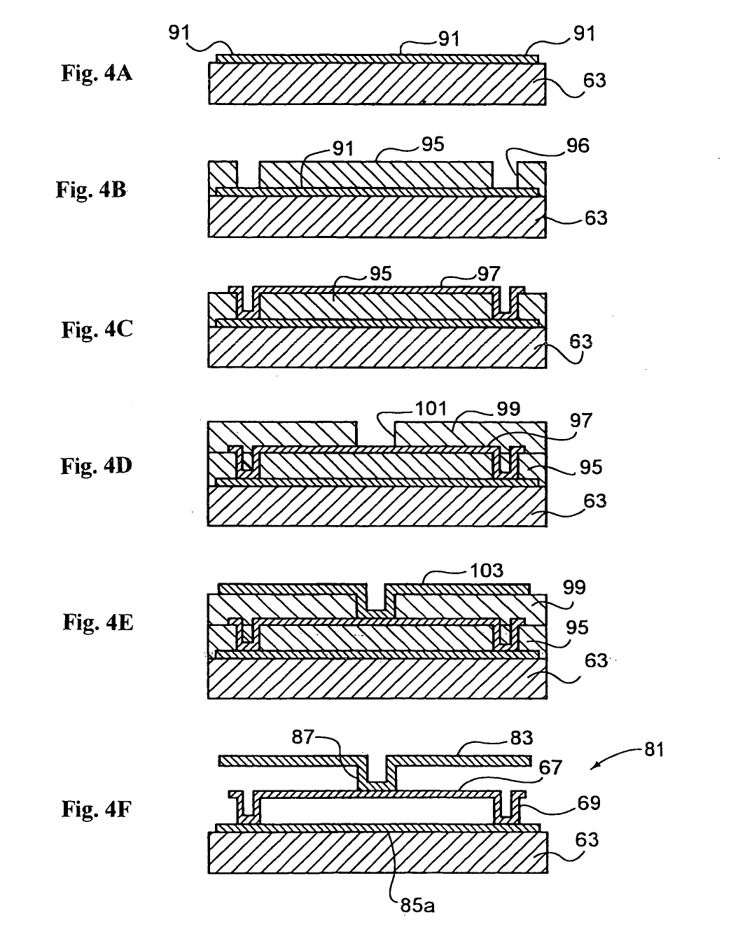

FIGS. 4A to 4F are drawings that explain the manufacturing procedure of the optical modulation elements illustrated in FIG. 2. Each of FIGS. 4A to 4F illustrates the cross section along line B-B in FIG. 2.

First, as shown in FIG. 4A, a first conductive film 91 is subjected to patterning on the substrate 63. The first conductive film 91 is subjected to sputtering with aluminum Al, preferably an Al alloy containing high melting point metals, and is then subjected to patterning by photolithography and etching, whereby the fixed electrodes 85a and 85b are formed.

As a preparation to be made before forming the first conductive film 91, a CMOS (Complementary Metal-Oxide Semiconductor) drive circuit (not show) is formed on the substrate 63, such as a silicon substrate, and a SiO₂ insulating film (not shown) is then formed on the CMOS drive circuit, furthermore the surface of the SiO₂ insulating film is then flattened by, for example, CMP (Chemical Metal Polishing), and a contact hole (not shown) used to connect the output of the drive circuit to each electrode of the element is formed.

Thereafter, as illustrated in FIG. 4B, a positive-type resist 95 serving as a first sacrificial layer is applied, and a first contact hole 96 is formed at a place to form the first support 69, and is subjected to hard baking. The hard baking is performed at a temperature exceeding 200° C. while projecting deep UV onto the positive-type resist 95 and the first contact hole 96. Thereby, the shape of the first contact hole 96 is maintained in a high-temperature process of the post-processing, and a state of being insoluble in a resist removing solvent is reached. Without depend on a level difference of a base film, surface of the resist is roughly flattened by a reflow effect caused when baked. To further flattening the surface of the resist, an etch-back process or a grinding process is carried out before forming the first contact hole 96.

The first sacrificial layer 95 is removed through a step described below. Therefore, the film thickness of the resist 95 obtained after having undergone the hard baking determines the gap of the fixed electrodes 85a and 85b and the hinge 67. A photosensitive polyimide can be used instead of the resist 95 serving as a sacrificial layer.

Thereafter, as shown in FIG. 4C, a second aluminum thin film (preferably, an aluminum alloy containing high melting point metals) serving as a second conductive film 97 is formed by sputtering. The second conductive film 97 is subjected to patterning by photolithography and etching so as to have a desired shape in which the hinge 67 and the first support 69 are formed. The aluminum film is etched according to wet etching with an aluminum etchant (a mixed solution composed of phosphoric acid, nitric acid, and acetic acid) or according to RIE (Reactive Ion Etching) dry etching with a chlorine-based gas.

Thereafter, as shown in FIG. 4D, a positive type resist 99 serving as a second sacrificial layer is applied, and a second contact hole 101 is formed at a place to form the supporting portion for micro mirror 87, and is subjected to hard baking. The hard baking is performed at a temperature exceeding 200° C. while projecting deep UV onto a positive type resist 99 and the second contact hole 101. Thereby, the shape of the second contact hole 101 is maintained in a high-temperature process described below, and a state of being insoluble in a resist removing solvent is reached. Without depend on a level difference of a base film, a surface of the resist is roughly flattened by a reflow effect caused when baked. To further flattening the resist surface, an etch-back process or a grinding process is carried out before forming the second contact hole 101. The second sacrificial layer 99 is removed through a step described below. Therefore, the film thickness of the resist obtained after having undergone the hard baking determines the gap of the micro mirror 83 and the hinge 67. A photosensitive polyimide resin can be used instead of the resist 99 serving as a sacrificial layer.

Thereafter, as illustrated in FIG. 4E, a third aluminum thin film (or, alternatively, an aluminum alloy) 103 serving as a third conductive film is formed by sputtering. The third conductive film 103 is subjected to patterning by photolithography and etching so as to obtain the micro mirror 83 having a desired shape. The aluminum film is etched according to wet etching with an aluminum etchant (a mixed solution composed of phosphoric acid, nitric acid, and acetic acid) or according to RIE dry etching with a chlorine-based gas.

Finally, as shown in FIG. 4(f), the resist layers serving as the first and second sacrificial layers 95 and 99 are removed so as to form a gap according to plasma etching (ashing) with an oxygen-based gas, thus forming the optical modulation element 81 having a desired structure.

This is a step of forming the optical modulation element 81. Conductive materials, as well as aluminum, can be used as the constructional materials of the micro mirror 83, the second support 87, the hinge 67, the first support 69, and the fixed electrodes 85a and 85b. For example, crystal silicon, poly-crystal silicon, metal (e.g., Cr, Mo, Ta, or Ni), metal silicide, or conductive organic material can be preferably used. Additionally, an insulating film (e.g., SiO₂ or SiNₓ) for protection can be stacked on the conductive member. Additionally, a hybrid structure can be used in which a conductive thin film made of, for example, a metal is stacked on an insulating thin film made of SiO₂, SiNₓ, BsG, a metal oxide film, a polymer, etc.

In the above embodiment, the resist is used as a sacrificial layer. However, the invention is not limited to this. For example, a metal, such as aluminum or cupper, or an insulating material, such as SiO₂, can be preferably used as a sacrificial layer. In this case, a material that is neither corroded nor damaged when the sacrificial layer is removed is appropriately selected as a constructional material.

Additionally, wet etching, as well as dry etching (plasma etching) mentioned above, can be employed as the sacrificial-layer removing method, depending on a combination of a known constructional material and a sacrificial layer. Preferably, in wet etching, a supercritical drying process or a freeze drying process is employed so that a constructional body does not cause sticking by surface tension in a rinse and drying step following the etching step. In the invention, structures, materials, processes, etc., are, of course, not limited to those mentioned above as far as these comply with the gist of the invention.

Therefore, according to the optical modulation element array 200, the micro mirror 83 can be floated and disposed above the hinge 67 and the first support 69. In other words, a space in which only the micro mirror 83 can be disposed is secured on the upper layer differing from the lower layer on which the hinge 67 and the supporting portion for micro mirror 69 are disposed. Therefore, a space to dispose the hinge 67 and the first support 69 and the area of the micro mirror 83 can be made larger, and optical efficiency in optical modulation can be made higher than in the conventional structure in which the hinge, the second support, and the micro mirror are disposed on the same plane.

Additionally, the length of the hinge 67 can be further increased in the axial direction, and hence low-voltage drivability and rapid responsibility can be improved.

Next, a third embodiment of the optical modulation element array according to an aspect of the invention will be described.

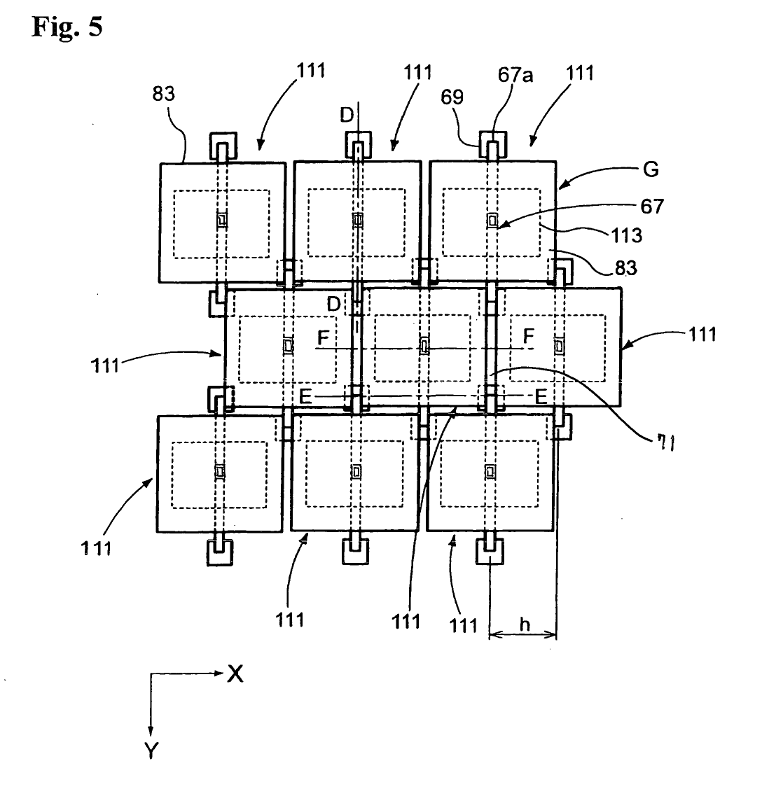

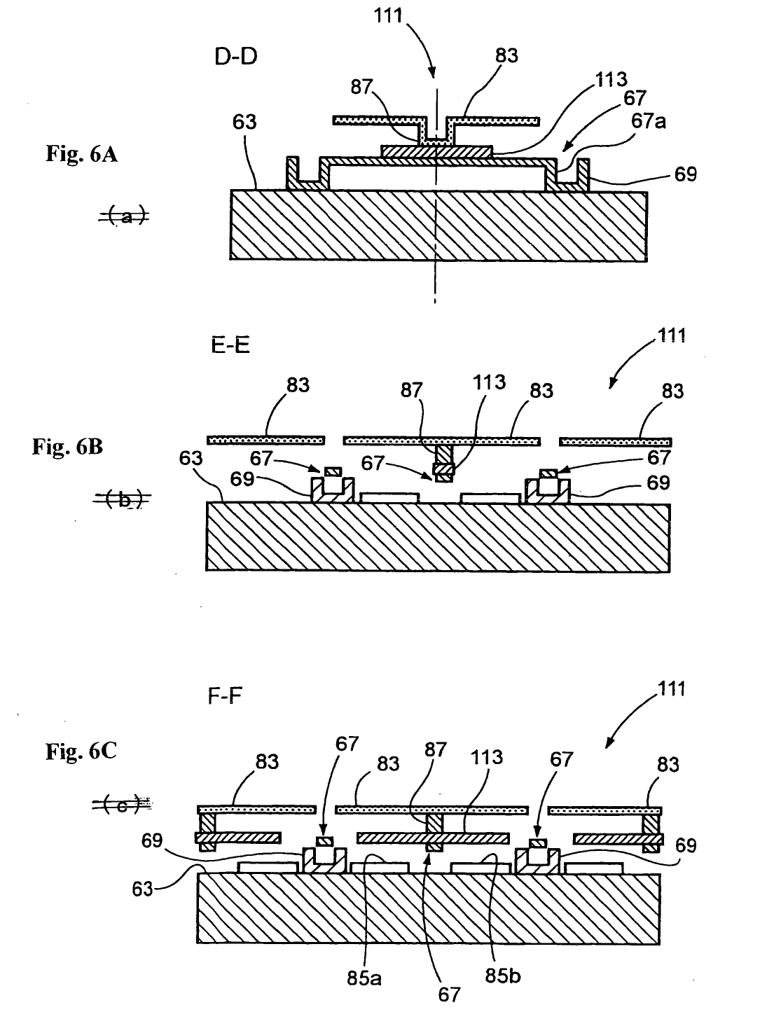

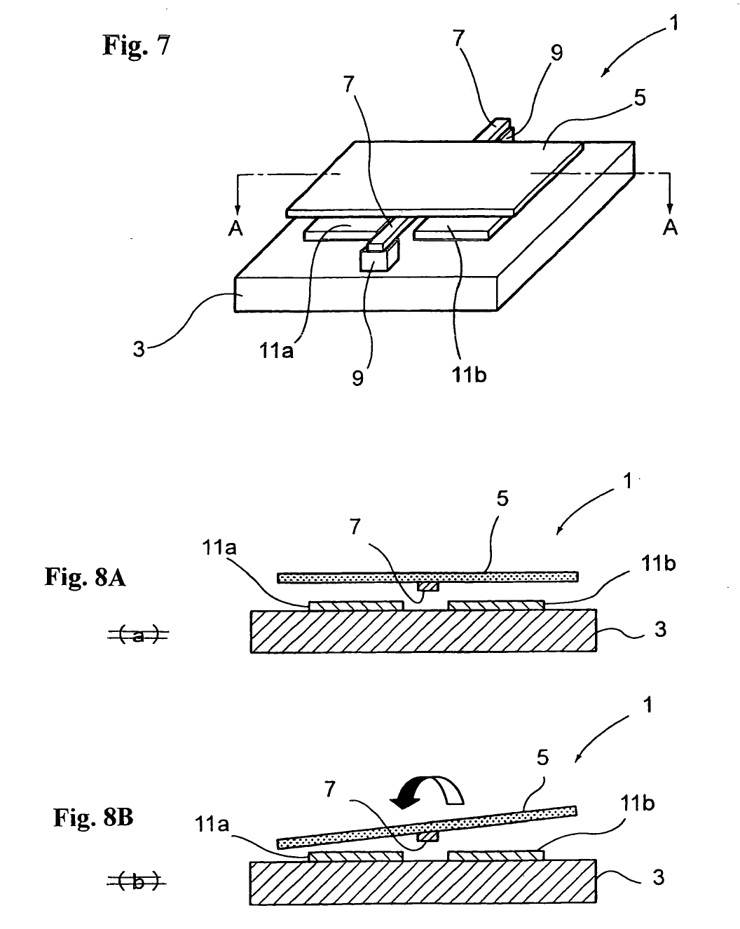

FIG. 5 is a plan view of the optical modulation element array according to the third embodiment in which a movable film is provided. FIGS. 6A to 6C are schematic explanatory drawings, FIG. 6A being a sectional view along line D-D in FIG. 5, FIG. 6B being a sectional view along line E-E in FIG. 5, FIG. 6C being a sectional view along line F-F in FIG. 5. In this embodiment, the same reference character is given to the same member as in FIGS. 1 and 2, and overlapping description thereof is omitted.

The optical modulation element array 300 includes an array of optical modulation elements 111. The optical modulation element 111 includes a micro mirror 83 provided above a substrate 63 (see FIGS. 6A to 6C, a hinge 67 supporting the micro mirror 83 so that the micro mirror 83 can be tilted, a first support 69 by which an end 67a of the hinge 67 is connected to the substrate 63, and a movable film 113.

In the optical modulation element array 300, according to a micro electromechanical technique, the optical modulation elements 111 are two-dimensionally arranged in a first direction and a second direction (i.e., X and Y directions of FIG. 5) that intersect perpendicularly each other. The first and second directions may be either the row-wise direction or the column-wise direction of an image formed by writing data about all pixels.

In the first direction X, the optical modulation elements 111 are linearly arranged side by side. On the other hand, in the second direction Y, the optical modulation elements 111 are arranged so that the optical modulation elements next to each other are shifted in the a first direction X (i.e., size “h” illustrated in FIG. 5) with respect to the optical modulation element 111 adjoining in the second direction Y. In the optical modulation element 111, the hinge 67 is formed in parallel with the second direction Y. The end 67a of the hinge 67 in each optical modulation element 111 is disposed in a gap 71 of the optical modulation element 111 adjoining in the first direction X.

In the optical modulation element 111, the hinge 67 has a second support 87 that protrudes toward an upper surface of the substrate 63. The micro mirror 83 is connected to the hinge 67 through the second support 87. The micro mirror 83 is floated and disposed by the second support 87, and becomes higher than the hinge 67 and the first support 69. As a result, the end 67a of the hinge 67 and the first support 69 can be disposed in the gap 71 without forming the cutout 73 (see FIG. 1) in the micro mirror 83. In other words, the micro mirror 83 is formed with the maximum area that does not need to form the cutout 73.

Further, the hinge 67 is provided with the movable film 113. The movable film 113 has electrode layers, not shown, and is connected to the hinge 67 while extending from the hinge 67 in parallel with the micro mirror 83. As illustrated in FIG. 6B, in the E-E cross section, the movable film 113 is formed on the upper surface of the hinge 67 with substantially the same width as the hinge 67. Fixed electrodes are provided on the substrate 63 in such a way as to face at least one of an area of the electrode layer, the area divided by the hinge 67. In this embodiment, as illustrated in FIG. 6C, a pair of fixed electrodes 85a and 85b are provided in such a way as to face the electrode layers of the movable film 113 on both sides of the hinge 67.

According to the optical modulation element array 300, an electrostatic force is generated between the electrode layers of the movable film 113 and the fixed electrodes 85a and 85b. This electrostatic force is used as the displacement drive source of the micro mirror 83. In other words, the movable film 113 that is nearer to the upper surface of the substrate 63 than to the micro mirror is allowed to generate an electrostatic force, and hence a greater electrostatic force can be obtained. Therefore, drivability at a lower voltage can be achieved, and the micro mirror 83 can respond at a greater speed.

In addition, any structure but the structures mentioned in the above embodiments can be employed as far as it complies with the gist of the present invention. For example, although the driving electrode is disposed on the substrate, the electrode can be placed at any point if it is nearer to the substrate than the micro mirror or the movable film. Additionally, each of the hinge, the first support, and the second support is not necessarily required to have the shape illustrated in the above embodiments.

Additionally, in the above embodiments, the optical modulation element has been described in which the micro mirror is used as an optical function film, and optical deflection is employed. However, it is permissible to use an optical modulation element of reflection type employing another optical function such as optical diffraction or optical interference.

Additionally, it is permissible to use an optical modulation element of transmission type in which an optical shielding film is used as an optical function film, and an optical shutter function is employed. Still additionally, an optical modulation element of transmission type may be used in which the wavelength selectivity of incident radiation is employed using an optical interference film of transmission type as an optical function film or in which still another optical function is employed. If the optical modulation element of transmission type is used, the substrate having an optical transmission is used. In the optical modulation element of transmission type, the use of a micro lens disposed on the incident side makes it possible to reduce the optical modulation area while stopping down the incident radiation so as to accomplish a higher-speed operation.

The present application claims foreign priority based on Japanese Patent Application (JP 2005-164571) filed Jun. 3 of 2005, the subject matter of which is hereby incorporated herein by reference.

What is claimed is:

1. An optical modulation element array comprising:
a substrate and
a plurality of optical modulation elements two-dimensionally arranged in a first direction and a second direction, the first direction being perpendicular to the second direction,
wherein
(1) the plurality of the optical modulation elements in the first direction are linearly arranged side by side, and the plurality of the optical modulation elements in the second direction are arranged so that optical modulation elements next to each other are shifted in the first direction,
(2) each of the plurality of the optical modulation elements comprises:
an optical function film provided above the substrate;
a hinge that supports the optical function film, the optical function film being capable of being tilted, wherein the hinge extends in parallel with the second direction; and
a first support that connects an end of the hinge with the substrate; and
(3) at least a portion of the end of the hinge is disposed in a gap between the optical modulation elements next to each other in the first direction, each of the plurality of the optical modulation elements next to each other in the first direction are located next to the optical modulation elements having the end of the hinge, in the second direction.

2. The optical modulation element array according to claim 1, wherein the entire portion of the end of the hinge is disposed in the gap.

3. The optical modulation element array as claimed in claim 1, wherein a height of the optical function film on the basis of an upper surface of the substrate is greater than that of the hinge and that of the first support.

4. The optical modulation element array as claimed in claim 1, wherein the optical function film has a second support, the second support protruding toward the upper surface of the substrate, and the second support connects the optical function film to the hinge.

5. The optical modulation element array as claimed in claim 1, which comprises:
a movable film having an electrode layer, supported by the hinge in parallel with the optical function film, and connected to the hinge; and
a fixed electrode provided on the substrate and facing at least one of an area of the electrode layer, the area divided by the hinge.

6. The optical modulation element array as claimed in claim 1, wherein the optical function film is a micro mirror.
